(19) United States
(12) Patent Application Publication
(10) Pub. No.: US 2012/0033932 A1
(43) Pub. Date: Feb. 9, 2012

(54) METHOD AND DEVICE FOR EDITING RECORDED IMAGES OF A DIGITAL VIDEO CAMERA

(76) Inventor: Klaus Jacumet, Munich (DE)

(21) Appl. No.: 13/264,367

(22) PCT Filed: Apr. 14, 2010
(86) PCT No.: PCT/EP2010/054882

§ 371 Date: Oct. 13, 2011

(30) Foreign Application Priority Data
Apr. 15, 2009 (DE) 10 2009 002 393.3

(51) Int. Cl. H04N 9/80

(52) U.S. Cl. 386/227; 386/E09.011

(57) ABSTRACT

A method for editing recorded images from a digital video camera. which images are projected from a cine lens connected to the digital video camera onto an imaging disk and, from the latter, onto an electronic sensor assembly, which converts the recorded images into recording signals provided as raw or RGB data, is provided. At least one calibration image is recorded, from which correction values are calculated for the grain structure of the imaging disk and/or the vignetting in the edge region of the recorded images. The recorded images are linked to the correction values.

### CROSS-REFERENCE TO A RELATED APPLICATION

This application is a National Phase Patent Application of International Patent Application Number PCT/EP2010/054882, filed on Apr. 14, 2010, which claims priority of German Patent Application Number 10 2009 002 393.3, filed on Apr. 15, 2009.

### BACKGROUND

The invention relates to a method and a device for editing recorded images from a digital video camera.

Digital video cameras with electronic image sensors for moving images are utilized in many areas of film and TV production. They contain one or more electronic image sensors and apply different sensor technologies, such as CCD or CMOS, when the electronic image sensors have different sizes.

Since it is easier to produce smaller electronic image sensors, digital video cameras equipped with these image sensors are more widely available. Here, an accepted disadvantage during use of these digital video cameras is that, inter alia, there is an increase in depth of field in the recorded object as a result of the small electronic image sensor. In many productions, this effect is undesirable because a small depth of field gives the option to the cameraman of directing the viewer's attention to a particular plane, e.g. to the face of an actor. The cameraman loses an essential style device, if the depth of yield is too big.

Specific parts of a film production are recorded using both a motion picture cine camera with a cine lens and a digital video camera. However, if the electronic image sensor in the digital video camera is smaller than the camera aperture of the digital video camera, the recorded scenes cannot be cut together because the respective angles of view do not fit together. For this reason, it is desirable for cine lenses used in motion picture cine cameras also to be used in digital video cameras.

However, using cine lenses for motion picture cine cameras in digital video cameras does not remove the aforementioned problem, which originates purely from the size of the electronic image sensor, because an optical adaptation using only imaging optics does not remove the disadvantage relating to a depth of field that is too large.

As per FIG. 1, in order to resolve this problem, an image from the cine lens 1 connected to the digital video camera is imaged on a ground-glass screen 2, which is arranged in the beam path of the video camera and the size of which corresponds to that of the desired image; this is the size of the film image in the case assumed above. This image is imaged, via relay optics 3, on the electronic image sensor 4, which is part of the digital video camera and connected to camera electronics 5. The reference sign 6 specifies the optical axis of the digital video camera.

In this arrangement, the ground-glass screen 2 decouples the two optical systems: the cine lens 1 on the one hand and the relay optics 3 or sensor assembly 4, 5 on the other hand. An analog/digital converter is part of the sensor assembly 4, 5; however, it is not illustrated separately in the schematic illustration as per FIG. 1. The signals output by the sensor assembly 4, 5 are digitized either in the electronic image sensor 4 itself or downstream thereof, and so the sensor assembly 4, 5 consists of the actual electronic image sensor 4, an analog/digital converter and the circuitry typically required for this in the digital video camera.

However, two new problems arise when solving the problem of also being able to use small electronic image sensors by decoupling the two optical systems by means of a ground-glass screen.

Firstly, the structure of the ground-glass screen used in the beam path of the digital video camera can be recognized in the image produced by the digital video camera, with the recognizable structure of the ground-glass screen becoming ever more visible as the stopping down of the cine lens increases. The use of a finer grain for the ground-glass screen does not yield an improvement because this would lift the decoupled state between the two optical systems in the digital video camera.

Secondly, there is vignetting in the edge region of the images recorded by the digital video camera as a result of non-matched pupil positions between the cine lens and the relay optics. Here, the amount of vignetting is dependent on the utilized cine lens and the position of the exit pupil. Although the keyhole effect caused by the vignetting is suppressed by the ground-glass screen, it is not removed completely, with the strength of the effect of the vignetting being dependent on the respectively utilized type of cine lens and on the lens aperture of an iris diaphragm of the cine lens.

In order to remove the ground-glass screen structure, DE 20 16 183 B has disclosed the practice of making a ground-glass screen oscillate rapidly within its areal plane; the grain structure of the ground-glass screen is smeared as a result of this. However, this method for removing or reducing the grain structure of the ground-glass screen is afflicted by the disadvantage that the design of the oscillation-generation device is very complicated due to the mechanically moved ground-glass screen because of the requirement that the ground-glass screen may only deviate by a few hundredths of a millimeter from its areal plane despite the fast oscillatory motion; otherwise the images recorded by the digital video camera become blurred.

Moreover, the fast oscillatory movement is connected to noises, with, in an implemented embodiment, the ground-glass screen rotating in its areal plane normal to the external surfaces since, in mechanical terms, this leads to the simplest mount. However, this leads to corresponding Coriolis forces when the video camera undergoes a panning motion, which Coriolis forces in turn put a load on the bearings of the rotational apparatus and/or influence the position of the ground-glass screen for the duration of the panning motion.

In any case, the vignetting problem is not removed by the rotating or oscillating ground-glass screen.

The document YU W: “PRACTICAL ANTI-VIGNETTING METHODS FOR DIGITAL CAMERAS” IEEE TRANSACTIONS ON CONSUMER ELECTRONICS, NEW YORK, N.Y., US, Volume 50, Number 4, November 2004 (2004-11), pages 975-983, XP001224730, ISSN 0098-3063 has disclosed a method for automatically correcting vignetting errors in images from a digital video camera; here, a reference image is recorded by the video camera and a correction factor is calculated for each pixel position, which results in a correction image that corresponds to the calculated correction factors in pixel values. Hereafter, images recorded by the same video camera are corrected by multiplying them by correction factors that are stored in a table. Missing correction factors are calculated by interpolation by applying hyperbolic-cosine functions.

This correction method requires very high computational intensity, both in generating the correction images and in correcting the recorded images and is not suitable for using cine lenses because the angles of view do not change.

### SUMMARY

The object on which the present invention is based is to specify a method and a device for editing recorded images from a digital video camera of the type mentioned at the outset, which, with little hardware and software intensity, allow the use of cine lenses without adversely affecting the image quality, even in conjunction with digital video cameras with a small electronic image sensor.

The solution according to the invention specifies a method and a device for editing recorded images from a digital video camera, in which a cine lens can also be used in conjunction with a digital video camera with a small electronic image sensor without this adversely affecting the image quality, in particular by the grain structure of an imaging disk, more particularly of a ground-glass screen or of a fiber plate, arranged in the beam path of the digital video camera becoming visible or by the occurrence of vignetting effects, wherein low hardware and software intensity is required for achieving a high image quality.

The solution according to the invention assumes decoupling between the optical systems, to be precise between the projection on the imaging disk of a recorded image using the cine lens on the one hand and the projection on the electronic image sensor of the imaging-disk image using relay optics on the other hand, and electronic correction of the image errors caused by using the cine lens and the imaging disk.

To this end, the digital video camera records a calibration image used to calculate correction values both for the grain structure on the imaging disk and for the vignetting in the edge region of the recorded images, and these correction values are linked after the calibration to the recorded images in the recording mode.

According to a further exemplary feature of the invention, since the effects of the grain structure on the ground-glass screen or fiber plate and the vignetting are dependent on the lens aperture of the cine lens, n vignetting and structure matrices are established for n different lens apertures of the cine lens. In the process, the following is taken into account: although the grain structure is independent of the lens aperture of the cine lens, the grain structure becoming visible ultimately is dependent on the lens aperture of the cine lens because if the lens aperture of the cine lens is small the light beams emerging from the cine lens impinge in parallel on the ground-glass screen such that the grain structure of the ground-glass screen is clearly visible, while in the case of large lens apertures the light beams emerging from the cine lens impinge on the ground-glass screen at different angles, and so the grain structure is not as clearly visible. As a result of this—albeit small—dependence of the grain structure on the lens aperture of the cine lens when considering the vignetting effects, the grain structure is also established at different lens apertures of the cine lens.

Since the vignetting effects and grain structures are also dependent on the respectively utilized lens type, the vignetting and structure matrices are, according to a further feature of the invention, respectively established for a particular cine lens type and used as correction values for the images from the digital video camera recorded during the recording operation.

The grain structure of the imaging disk is established when the imaging disk is installed. For this purpose, arranged in the beam path of the digital video camera are the cine lens, the imaging disk embodied as a ground-glass screen or fiber plate, relay optics and the electronic image sensor apparatus for generating one or more correction images used to calculate the correction matrices for the grain structure of the imaging disk and the vignetting effects, the individual values of which then serve in the recording mode of the digital video camera for correcting the recorded images.

The recorded images from the recording mode of the digital video camera can be corrected electronically either on the level of the raw sensor data or in the RGB color space after image processing.

In order to establish the correction matrices, correction values are generated for each pixel in the calibration image, by
establishing the mean brightness of the overall calibration image distributed over the calibration image,
establishing for each pixel of the calibration image a local mean value of the brightness for a prescribable number of pixels neighboring a determination pixel,
forming the ratio of the mean brightness of the overall calibration image and the local mean value of the brightness for a prescribable number of pixels, which are neighboring the determination pixel,
   and in that the correction values established thus are stored in a vignetting matrix for each determination pixel, wherein a structure matrix is generated and stored as an image of the structure of the ground-glass screen from the ratio of the local mean value of the brightness for a prescribable number of pixels, which are neighboring a determination pixel, and the brightness of each determination pixel of this prescribed number of adjacent pixels.

This method for establishing and processing the correction matrices by averaging over adjacent regions, for example over a block of 36 or 49 pixels, leads to very good results but requires increased computational intensity. For simplification purposes, it is also possible to obtain only local mean values of the brightness for a prescribable number of pixels, e.g. 20 pixels, in a current line for both the vignetting and the structure matrix.

The correction matrices can either be calculated from the calibration images in a data processing unit of the digital video camera and said correction matrices can be correlated to the recorded images in a recording mode of an image processing unit of the digital video camera, or the calibration images recorded by the digital video camera are output as a video signal at an image output of the digital video camera and transferred to an external PC, in which the correction matrices are calculated and returned to the image processing unit in the digital video camera via a data interface and said correction matrices are correlated to the recorded images in a recording mode of the digital video camera.

In the recording mode of the digital video camera, the recorded images are corrected in a real-time capable system, for example in a programmable logic component (FPGA—field programmable gate array), in which each individual pixel in the recorded image is firstly multiplied by the same pixel in the vignetting matrix and then multiplied by the same pixel in the structure matrix such that those points that are too dark as a result of the ground-glass screen structure or vignetting have the individual pixels multiplied by a factor greater than 1 and hence they are brightened, while those points that are too bright as a result of the grain structure of the ground-glass screen or the vignetting are multiplied by a factor of less than 1 and hence they are darkened, and so this results in a consistent recorded image that is free from the influences of the grain structure and vignetting.

In order to take into account the lens aperture of the respectively utilized cine lens, the values of the lens aperture of the cine lens are detected by a sensor connected to the cine lens and stored together with the correction values of the pixels.

If the cine lens does not have appropriate sensors such that it is not possible to enter electronically the values of the lens aperture of the cine lens, both the correction factors and the switching between the different correction matrices, recorded dependent on the lens aperture of the cine lens, can also be entered manually.

The device according to the invention for editing recorded images from a digital video camera with a cine lens for projecting recorded images onto an imaging disk, arranged in the beam path of the cine lens, of the digital video camera, an electronic image sensor apparatus and an image processing unit with
a processor,
an apparatus for outputting image signals,
a buffer memory for storing calibration images, connected, on the input side, to the apparatus for outputting the image signals and, on the output side, to the processor,
a vignetting-matrix memory connected, on the input side, to the processor,
a structure-matrix memory connected, on the input side, to the processor,
a plurality of multipliers connected to the vignetting-matrix memory, the structure-matrix memory and the apparatus for outputting the image signals, and
an output unit for a corrected recorded image connected to the multipliers.

### BRIEF DESCRIPTION OF THE DRAWINGS

The idea on which the invention is based is to be explained in more detail on the basis of exemplary embodiments illustrated in the drawing.

FIG. 1 shows a schematic block diagram of a digital video camera with an imaging disk.

FIG. 2 shows a schematic block diagram of a digital video camera video camera with imaging disk and an image processing unit.

FIG. 3 shows a block diagram of the image processing unit integrated in the digital video camera.

FIG. 4 shows an example for the profile of the brightness distribution in a video line.

FIG. 5 shows a flowchart for generating correction matrices from the calibration image(s).

FIG. 6 shows a graph of a vignetting matrix for correcting real recorded images.

FIG. 7 shows a graph of a structure matrix for correcting real recorded images.

FIG. 8 shows a graph of a simplified vignetting matrix for correcting real recorded images.

FIG. 9 shows a flowchart for camera internal or external calculation of the correction matrices and for the pixel-by-pixel correction of real recorded images.

### DETAILED DESCRIPTION

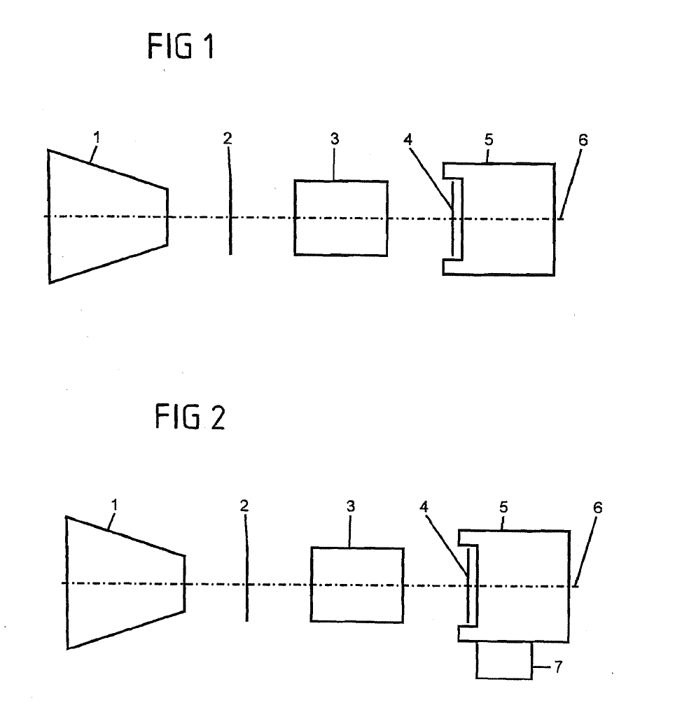

FIG. 2 shows the block view of a digital video camera modified with respect to the circuitry design of the digital video camera as per FIG. 1. Arranged on the optical axis 6 of a cine lens 1 is a ground-glass screen or fiber plate 2, relay optics 3 and an electronic image sensor 4 which is connected to image electronics 5. The cine lens 1 is used to image a recorded image on the ground-glass screen or fiber plate 2, the size of the latter ideally corresponding to the size of the recorded image. The recorded image is then imaged, via the relay optics 3, on the electronic image sensor 4 with downstream image electronics 5. An analog/digital converter is part of the electronic image sensor 4 or the image electronics 5 and not illustrated separately in the schematic illustration as per FIG. 2. The signals output by the sensor assembly 4, 5 (which is formed from the electronic image sensor 4 and the downstream image electronics 5) are digitized either in the electronic image sensor 4 itself or thereafter, and so the sensor assembly 4, 5 consists of the actual electronic image sensor 4, an analog/digital converter and the circuitry typically required for this in the digital video camera.

In the arrangement of components of a digital video camera described previously, an image sensor that is smaller than the image field of the digital video camera may be used for converting the moving recorded images. However, it is possible to identify the structure of the ground-glass screen in the image of the digital video camera in this arrangement; and this always increases with increasing dimming of the cine lens, i.e. as the size of the lens apertures decreases. Moreover, vignetting can be identified in the edge region of the recorded images as a result of non-matched pupil positions between the cine lens and the relay optics, particularly if the cine lenses are made by different manufacturers and hence the position of the exit pupil is not defined in any way. Although the keyhole effect created by the vignetting is reduced by the ground-glass screen, it is not completely removed.

In order to remove the grain structure, which is caused by the ground-glass screen, and the vignetting effect, the arrangement of a digital video camera illustrated in FIG. 1 is, as per FIG. 2, extended by an image processing unit 7. This image processing unit 7 is either integrated into the digital video camera or placed externally, downstream of the digital video camera, as a complete unit.

Alternatively, it is possible that only the time-critical part is embodied as a component of the digital video camera while a processor for calculating correction matrices is arranged externally.

In a further alternative, the entire image processing unit 7 can additionally be attached outside of the actual video camera, and so there is no need to interfere with the actual video camera in order to use the solution according to the invention.

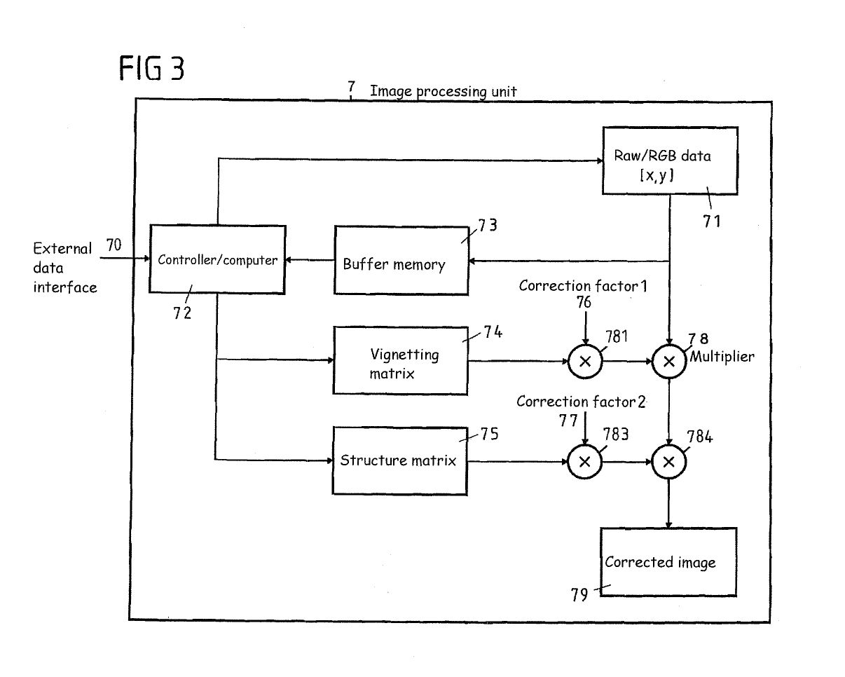

FIG. 3 shows a block diagram of an image processing unit 7 integrated in the digital video camera.

The image processing unit 7 contains a controller or computer 72, which edits the raw or RGB data 71 output by the sensor assembly 4, 5 and/or outputs the raw or RGB data 71 and is connected, on the input side, to an external data interface 70 and to a buffer memory 73, to which, on the input side, the raw or RGB data 71 is applied. On the output side, the controller/computer 72 is connected to both a vignetting-matrix memory 74 and a structure-matrix memory 75. The output of the vignetting-matrix memory 74 is connected to a first multiplier 781, to which, additionally, a first correction factor 72 is applied and, on the output side, is routed to an input of a second multiplier 782, with the raw or RGB data 71 being routed to the second input of the latter. The output of the structure-matrix memory 75 is routed to a first input of a third multiplier 783, wherein a second correction factor 77 is applied to a second input and the output thereof is routed to a first input of a fourth multiplier 784, the second input of which is connected to the output of the second multiplier 782 and on the output of which a corrected recorded image 79 is output.

At least one calibration or correction image is generated with the aid of the design of a digital video camera illustrated in FIG. 2, from which correction matrices for the grain structure of the ground-glass screen 2 and for the vignetting are either calculated internally in the camera by means of the controller/computer 72 or output as a video signal via an image output of the digital video camera and transmitted to an external PC in which the correction matrices are calculated and returned to the image processing unit of the digital video camera via a data interface. These correction matrices then serve in the live or recording mode for correcting the moving recorded images, wherein the electronic correction optionally intervenes on the level of the raw sensor data or in the RGB color space after the image processing.

Since the effects of the grain structure and the vignetting are dependent on the lens aperture of the cine lens 1, a plurality of correction matrices are established at different lens apertures of the cine lens 1 for the grain structure of the ground-glass screen 2 and for the vignetting. Moreover, in the case of different types of cine lenses, a plurality of correction matrices are produced for the different lens apertures together with a specification of the lens type.

The following text describes the method according to the invention for editing recorded images from a digital video camera or the function of the image processing unit 7 illustrated in FIG. 3.

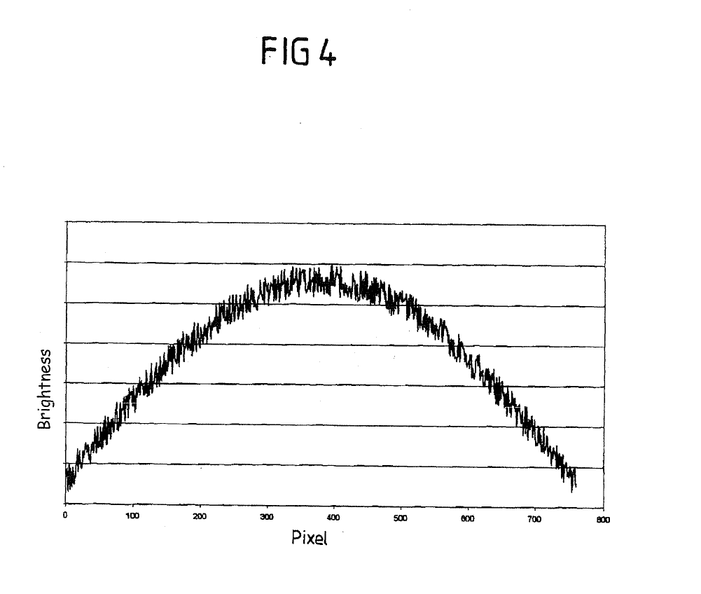

FIG. 4 shows an example of the profile of the brightness distribution in a video line with 760 pixels. This illustration clearly shows the high-frequency component of the ground-glass screen structure, on which a basic reduction in the brightness toward the edges as a result of the vignetting effect is superposed. The changes in brightness, caused by the ground-glass screen structure and the vignetting effect, in the individual pixels of the video line are compensated for with the aid of the correction method according to the invention by firstly generating correction matrices for the grain structure and the vignetting.

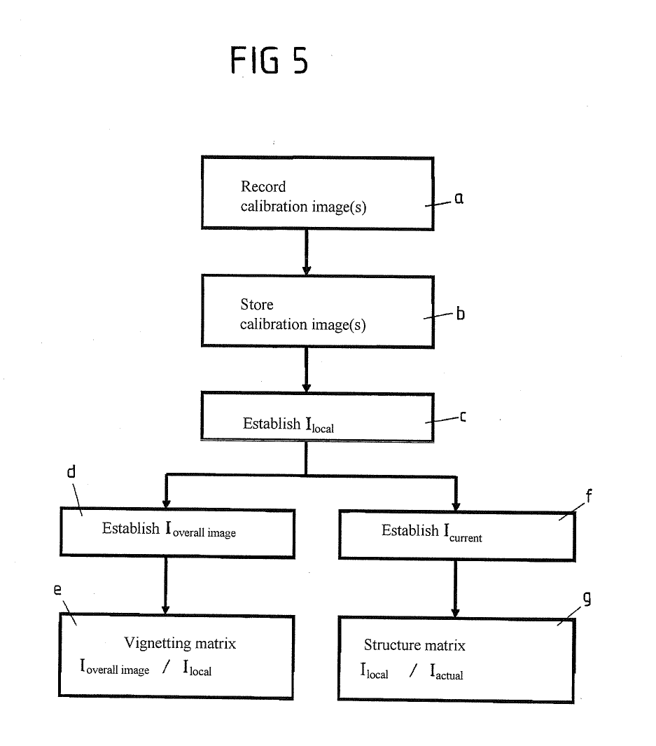

The flowchart illustrated in FIG. 5 is used to explain how correction matrices are generated from the calibration image or the calibration images. First of all, a calibration image is recorded by the sensor assembly 4, 5 in step a and stored in the buffer memory 73 in step b. In step c, a local mean value is calculated for each pixel from the adjacent pixels, for example from a pixel region with 36 or 49 adjacent pixels. The mean brightness distribution over the entire image is calculated in step d by the controller/computer 72. The high-frequency influence of the ground-glass screen structure is removed by averaging the brightness distribution over the adjacent pixels and a uniform curve of the brightness distribution over the image cross section is generated; said distribution reproduces the vignetting effect.

If the local brightness of the correction image is brighter than the mean of the overall image, the ratio

I_{mean overall image}/I_{local current mean}

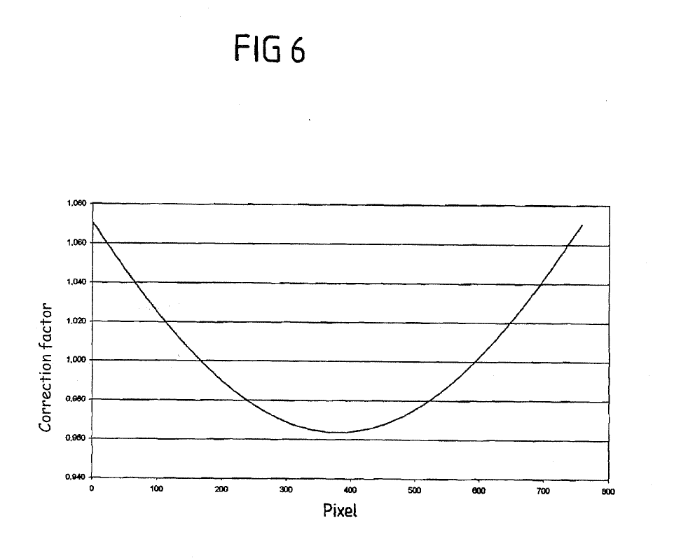

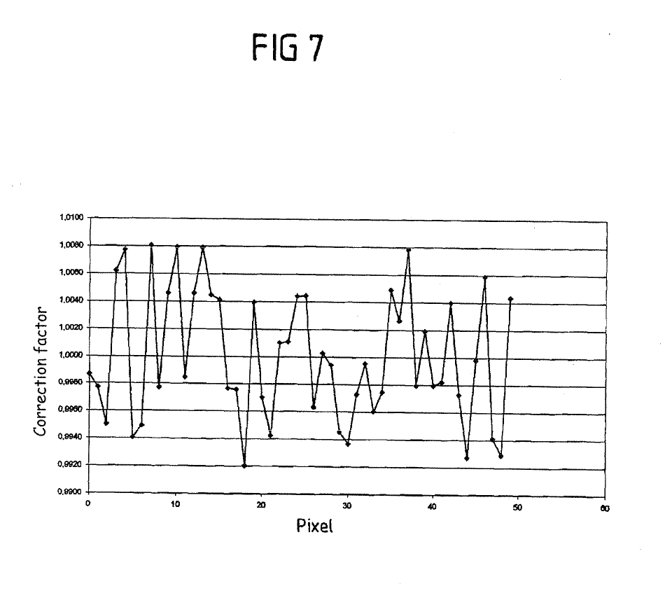

results in a value of less than 1. If the current value of the local brightness of the correction image is darker than the mean of the overall image, the aforementioned ratio results in a value of greater than 1. The vignetting matrix formed in step e and illustrated in a graph in FIG. 6 is stored in the vignetting-matrix memory 74.

The deviation of each pixel from the local average is established in step f. This generates an image of the ground-glass screen structure in the form of a structure matrix. If the brightness of a pixel in the correction image is greater than the local mean, the ratio

I_{local current mean}/I_{current}

results in a value of less than 1. If the brightness value of a pixel in the correction image is darker than the local mean, this results in a value of greater than 1. The structure matrix generated in step g and illustrated in a graph in FIG. 7 is stored in the structure-matrix memory 75.

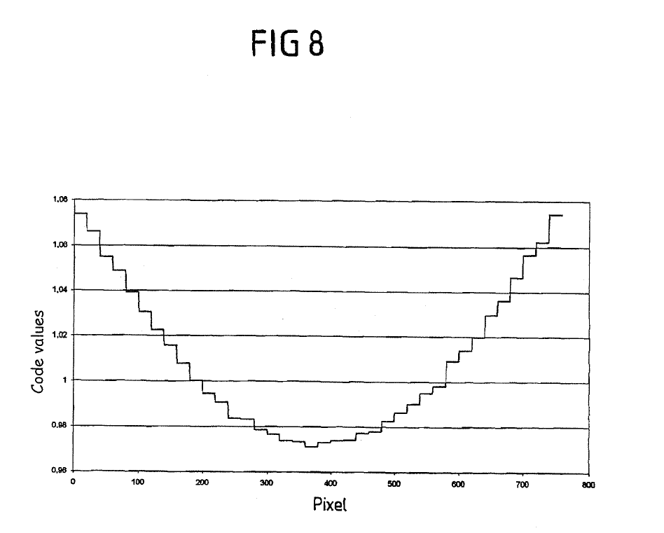

Very good results are obtained by the method described above of averaging the brightness distribution over adjacent regions, for example over a block of 36 or 49 pixels; however, it is very computationally intensive. In order to simplify this, it is possible to use only local values from 20 pixels of the respectively current video line for both the vignetting and the structure matrix. This results in a simplified vignetting matrix as illustrated in FIG. 8.

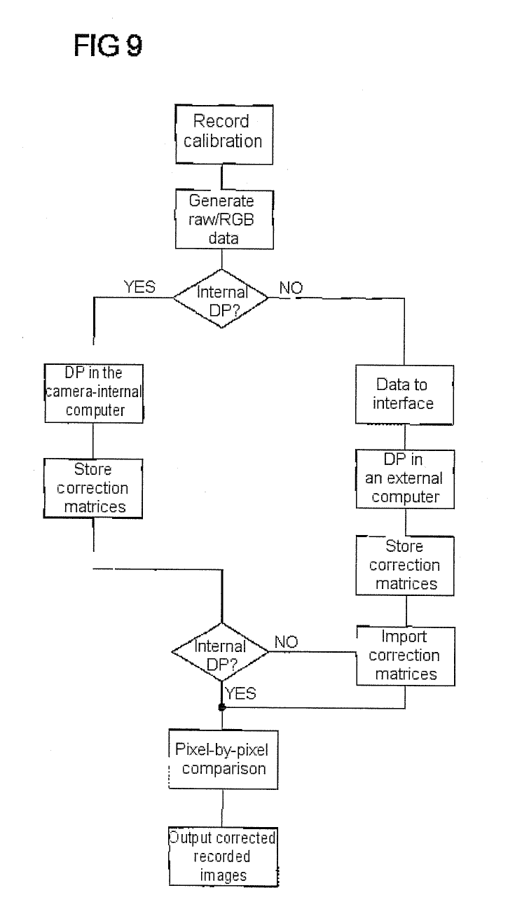

As per the flowchart illustrated in FIG. 9, a small microcontroller can be used as hardware for calculating the correction matrices in the case of camera-internal data processing because this process is only carried out during calibration and hence it is not time critical. Alternatively, use can be made of a computational core in a programmable logic component or logic array, for example in a field programmable gate array.

Particularly for the purpose of editing relatively large amounts of data, for example for the purpose of generating correction matrices for a number of lens apertures of different types of cine lenses, the calibration images may, for external data processing, be output as video signals at the image output of the image electronics 5 and transmitted from there to an external computer, for example as a video image via a frame-grabber card. The correction matrices are calculated in the external computer and all correction matrices, or the respectively required ones, are output to the image processing unit 7 via the data interface 70, for example an Ethernet, USB or similar interface, in which image processing unit they are stored in the vignetting-matrix memory 74 and structure-matrix memory 75 for pixel-by-pixel comparison with the real recorded images.

Correcting the actual recorded images from the digital video camera must be implemented in a real-time capable system, for example by means of a field programmable gate array. The individual pixels in the recorded image 71 are first of all multiplied by the pixel output by the vignetting-matrix memory 74 that is stored at the same address. This is followed by multiplication by the pixel with the same address output by the structure-matrix memory 75. By multiplying each pixel in a recorded image by the same pixels in the calibration image, points that are too dark as a result of the pixel graininess or vignetting are multiplied by a factor of greater than 1 and hence these are brightened, whilst points that are too bright as a result of the pixel graininess or vignetting are multiplied by a factor of less than 1 and hence these are darkened, and so, overall, the recorded image is freed from the influence of the grain structure and vignetting.

Use can be made of two different methods for taking account of the influence of the lens aperture in the cine lens 1.

In a first method, a plurality of correction images are established for different diaphragms and these are then reapplied in the case of the corresponding diaphragms in the recording mode.

In a second method, use is made of the two additional correction factors 76, 77, which act on the two correction matrices. To this end, provision is made for the first multiplier 781 and the third multiplier 783, with the correction factors 76, 77 being dependent on the respective lens aperture of the cine lens 1.

1.-19. (canceled)

20. A method for editing recorded images from a digital video camera, which images are projected from a cine lens connected to the digital video camera onto an imaging disk and, from the latter, onto an electronic sensor assembly, which converts the recorded images into recording signals provided as raw or RGB data, wherein at least one calibration image is recorded, from which correction values are calculated for the grain structure of the imaging disk and/or the vignetting in the edge region of the recorded images, and wherein the recorded images are linked to the correction values.

21. The method as claimed in claim 20, wherein a number of n vignetting and structure matrices are established for n different lens apertures in a cine lens.

22. The method as claimed in claim 21, wherein the vignetting and structure matrices are respectively established for a specific cine lens type.

23. The method as claimed in claim 20, wherein the recorded images are corrected electronically at the level of the raw sensor data output by the sensor assembly.

24. The method as claimed in claim 20, wherein the recorded images are corrected in the RGB color space from the raw sensor data output by the sensor assembly after image processing.

25. The method as claimed in claim 20, wherein correction values are generated for each pixel in the calibration image, by
establishing the mean brightness of the overall calibration image distributed over the calibration image,
establishing for each pixel of the calibration image a local mean value of the brightness for a prescribable number of pixels neighboring a determination pixel,
forming the ratio of the mean brightness of the overall calibration image and the local mean value of the brightness for a prescribable number of pixels, which are neighboring the determination pixel,
and in that the correction values established thus are stored in a vignetting matrix for each determination pixel.

26. The method as claimed in claim 25, wherein a structure matrix is generated and stored as an image of the structure of the imaging disk from the ratio of the local mean value of the brightness for a prescribable number of pixels, which are neighboring a determination pixel, and the brightness of each determination pixel of this prescribed number of adjacent pixels.

27. The method as claimed in claim 20, wherein the vignetting matrix and the structure matrix are established from the local mean value of the brightness for a prescribable number of pixels in a line.

28. The method as claimed in claim 27, wherein the prescribed number of pixels consists of twenty pixels in a line.

29. The method as claimed in claim 20, wherein the recorded images are corrected in a real-time capable system.

30. The method as claimed in claim 20, wherein each pixel in a recorded image is multiplied by the correction value of the same pixel stored in the vignetting matrix and the structure matrix.

31. The method as claimed in claim 20, wherein the values of the lens aperture of a cine lens are detected by a sensor connected to the cine lens and stored together with the correction values of the pixels.

32. The method as claimed in claim 20, wherein the vignetting matrix and the structure matrix are entered manually for a specific lens aperture of a cine lens.

33. A device for editing recorded images from a digital video camera with a cine lens for projecting recorded images onto an imaging disk, arranged in the beam path of the cine lens, of the digital video camera, a sensor assembly and an image processing unit comprising
a processor,
an apparatus for outputting image signals,
a buffer memory for storing calibration images, connected, on the input side, to the apparatus for outputting the image signals and, on the output side, to the processor,
a vignetting-matrix memory connected, on the input side, to the processor,
a structure-matrix memory connected, on the input side, to the processor,
a plurality of multipliers connected to the vignetting-matrix memory, the structure-matrix memory and the apparatus for outputting the image signals, and
an output unit for a corrected recorded image connected to the multipliers.

34. The device as claimed in claim 33, wherein the processor consists of a low-power microcontroller for calculating the correction matrices.

35. The device as claimed in claim 33, wherein the processor consists of a calculation core from a programmable logic component or logic array, in particular a field programmable gate array.

36. The device as claimed in claim 33, further comprising a data interface for outputting video signals, in particular as a video image via a frame-grabber card, to an external computer, which calculates the correction matrices and outputs the result to the image processing unit via the data interface.

37. The device as claimed in claim 33, further comprising a real-time capable system for correcting the real recorded images from the digital video camera, which system multiples each pixel in the real recorded image by a pixel, which is output by the vignetting-matrix memory and stored at the same address, the product is multiplied by the pixel at the same address output by the structure-matrix memory, wherein, as a result of multiplying each pixel in a recorded image by the same pixels in the calibration image points that are too dark as a result of the pixel graininess or vignetting are multiplied by a factor greater than 1 while points that are too bright as a result of the pixel graininess or vignetting are multiplied by a factor of less than 1.

38. The device as claimed in claim 37, wherein the real-time capable system consists of a field programmable gate array.
